(19) United States
(12) Patent Application Publication
(10) Pub. No.: US 2026/0367486 A1
(43) Pub. Date: Nov. 19, 2026

(54) PHOTOGRAPHIC ACCESSORY

(71) Applicant: Ningbo Laobei Photographic Equipment Co., Ltd., Ningbo City (CN)

(72) Inventor: Tiancheng Pan, Cixi City (CN)

(21) Appl. No.: 19/728,242

(22) Filed: Jul. 1, 2026

(30) Foreign Application Priority Data
Nov. 6, 2025 (CN) 202522364028.X

(51) Int. Cl. G03B 15/06

(52) U.S. Cl. CPC G03B 15/06

(57) ABSTRACT

A photographic accessory is provided, including a housing and at least one optical auxiliary component accommodated within the housing; the optical auxiliary component is provided with at least one of a light-diffusing portion, a light-reflecting portion, and a light-absorbing portion; the housing has at least one opening, and when in use, the optical auxiliary component extends at least partially from the opening so that at least one of the light-diffusing portion, the light-reflecting portion, and the light-absorbing portion is always in an unfolded state. The present disclosure features a simple structure and can be used as a fill board, reflector or diffuser during photography and videography.

### TECHNICAL FIELD

The present disclosure belongs to the field of photographic auxiliary equipment technology, and specifically relates to a photographic accessory.

### BACKGROUND

Photography is a process of recording images using specialized equipment. We generally use mechanical cameras or digital cameras for photography. Photography is sometimes called taking pictures, which is a process of exposing a photosensitive medium to light emitted or reflected by an object. For example, in the current photography and videography process, light-diffusing devices are added, that is, a light source passes through a light-diffusing layer to form soft light before photography. Another example is the device for absorbing light in the case of excessive light. Therefore, it is very important to obtain a photographic accessory that can be applied to the preceding scenarios.

### SUMMARY

To solve at least one of the preceding technical problems, the present disclosure provides a photographic accessory, including a housing and at least one optical auxiliary component accommodated within the housing;
at least a part of the optical auxiliary component is provided with at least one of a light-diffusing portion, a light-reflecting portion, a light-absorbing portion, and a light-transmitting portion; and
at least one opening is provided on the housing; when at least a part of the optical auxiliary component extends out from the opening, at least one of the light-diffusing portion, the light-reflecting portion, the light-absorbing portion, and the light-transmitting portion is in an unfolded state.

Light is directed to a first side of the optical auxiliary component and passes through the light-diffusing portion before exiting from an auxiliary irradiation surface of the light-diffusing portion located on a second side of the optical auxiliary component, and the light-diffusing portion includes a light-diffusing cloth or light-diffusing paper.

Light is directed to the first side of the optical auxiliary component, the light is reflected after passing through the light-reflecting portion, and the light-reflecting portion is a reflective coating.

Light is directed to the first side of the optical auxiliary component, light passing through the light-absorbing portion is partially absorbed and reflected, and the light-absorbing portion is made of black velvet.

Light is directed to the first side of the optical auxiliary component, causing the light to pass through the light-transmitting portion and then transmit from a light-transmitting side of the light-transmitting portion located on the second side of the optical auxiliary component, in which the light-transmitting portion is a via hole opened on the optical auxiliary component, or the optical auxiliary component is made of transparent material, and the optical auxiliary component is coated with at least an opaque coating, with light passing through the transparent material that is not coated with the opaque coating and being emitted.

The optical auxiliary component is made of an opaque or low-light-transmitting material; the optical auxiliary component is made of a flexible material so that the optical auxiliary component is wound onto a spool inside the housing after being accommodated.

The optical auxiliary component includes several rigid components that are movably or flexibly connected so that the optical auxiliary component can be at least partially bent or folded, and so that the optical auxiliary component is placed in the housing after being folded or bent.

The optical auxiliary component further includes a supporting structure, and the supporting structure acts on the optical auxiliary component to at least partially unfold the optical auxiliary component.

The supporting structure includes at least one folding rod assembly, the folding rod assembly includes a first rod body and a second rod body, and the first rod body and the second rod body are rotatably connected by means of a connecting structure.

The connecting structure includes a first rotating connector connected to the first rod body, a second rotating connector connected to the second rod body, and a rotating shaft connecting the first rotating connector and the second rotating connector; the second rotating connector is provided with a drive unit to drive the rotating shaft to rotate, and the first rotating connector is provided with a rotating via hole to allow the rotating shaft to rotate circumferentially within the rotating via hole.

The connecting structure further includes a limiting structure, and the limiting structure includes a limiting member that rotates with the rotating shaft, at least two bulges respectively provided on the opposite contact surfaces of the limiting member and the first rotating connector, and a groove fitted with the bulges.

The two bulges are arranged at 180 degrees to limit and lock the first rod body and the second rod body in a folded state and in an unfolded straight state; the limiting structure further includes an elastic member disposed between the second rotating connector and the limiting member to abut the limiting member against the first rotating connector.

A first end of the optical auxiliary component is secured on the spool within the housing, a second end is provided with a support rod, a first end of the first rod body is hinged to the support rod, a second end of the second rod body is hinged to an inner wall of the housing, and a second end of the first rod body is hinged to a first end of the second rod body.

A length of the support rod is adapted to a width of the optical auxiliary component, and two folding rod assemblies are provided and respectively arranged at both ends of the support rod, so that when the folding rod assemblies are unfolded, they are placed on both sides of the optical auxiliary component to prevent blocking light; a limiting wall is provided on the support rod at the hinge point with the first rod body.

A limiting groove is provided on the inner wall of the housing, and a lock tongue is movably connected to the cover, the lock tongue disengaging from or entering the limiting groove to achieve unlocking or locking; the support rod serves as the cover of the housing, and a handle is mounted on the support rod serving as the cover.

A support leg is rotatably connected to the housing, and a limiting protrusion for limiting rotation angles of the support leg is provided on the housing; a mounting rod is detachably connected to the housing, and the mounting rod is limited and secured by means of a locking piece.

Compared with the prior art, the advantages of the present disclosure are as follows: The present disclosure features a simple structure and can be used as a fill board, reflector or diffuser during photography and videography.

### BRIEF DESCRIPTION OF DRAWINGS

FIG. 1 is a stereoscopic view of an unfolded structure;

FIG. 2 is a cross-sectional diagram I of the present disclosure folded and stored inside;

FIG. 3 is a stereoscopic view of the present disclosure folded and stored inside;

FIG. 4 is a cross-sectional diagram II of the present disclosure folded and stored inside;

FIG. 5 is a diagram illustrating a light transmission cross-section of an optical auxiliary component of the present disclosure, which is entirely a light-diffusing portion (the light rays are represented by gray arrows);

FIG. 6 is a diagram illustrating a light transmission cross-section integrated by an optical auxiliary component of the present disclosure (the light rays are represented by gray arrows);

FIG. 7 is a diagram illustrating a structure of a light-transmitting portion, in the form of a via hole, of an optical auxiliary component of the present disclosure;

FIG. 8 is a stereoscopic view of a folding rod assembly in its folded state;

FIG. 9 is an exploded view of FIG. 8.

FIG. 10 is a stereoscopic view of a folding rod assembly in its unfolded state;

FIG. 11 is an exploded view of FIG. 10.

FIG. 12 is a top view of a lock tongue section;

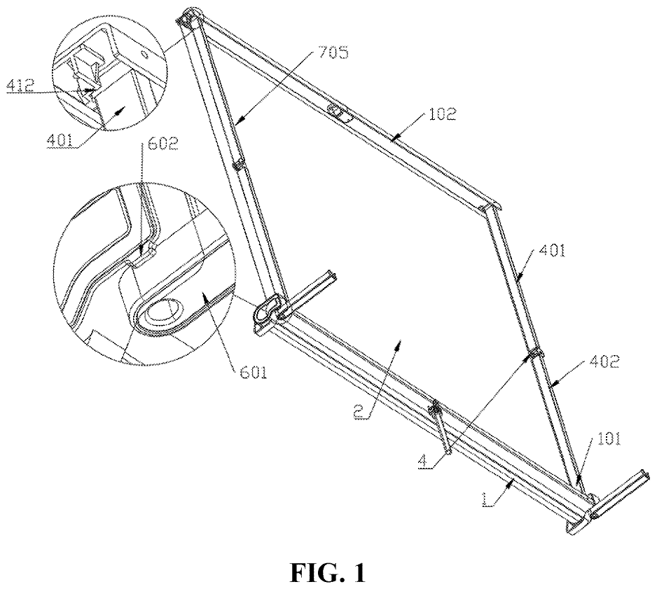

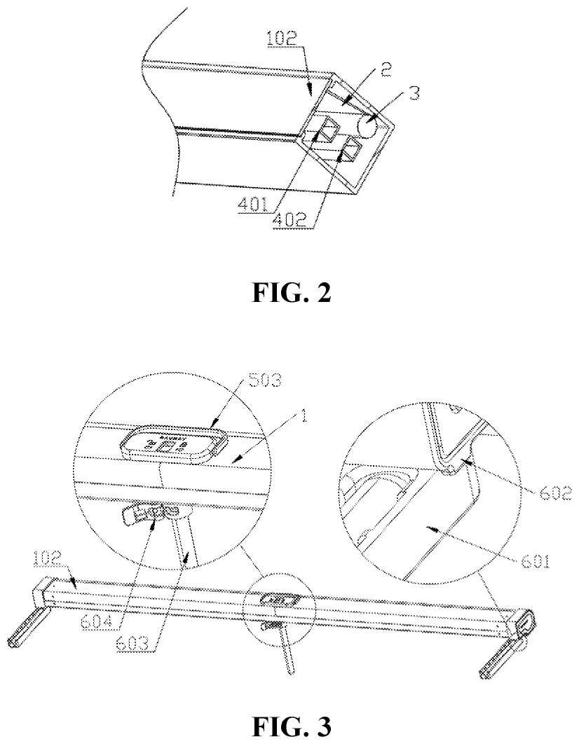

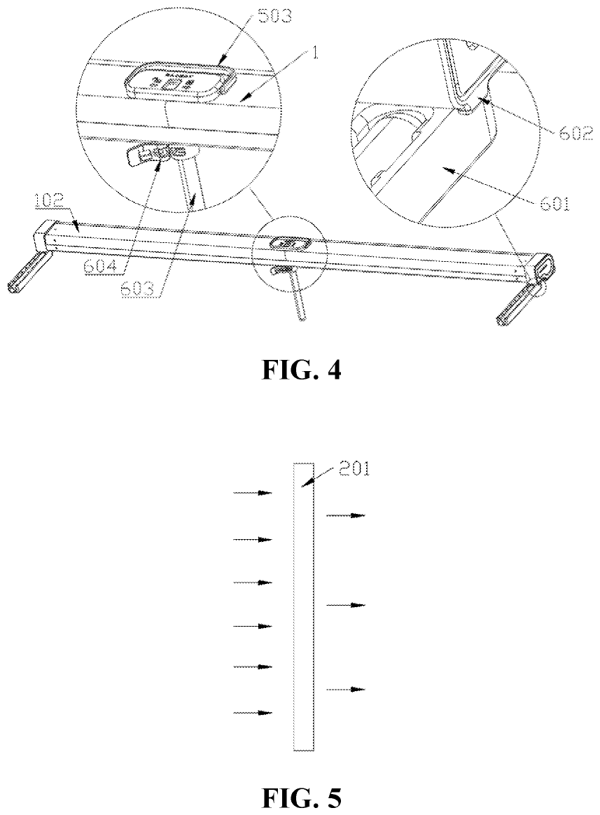

Reference numerals: 1. Housing; 101. Opening; 102. Support rod; 2. Optical auxiliary component; 201. Light-diffusing portion; 202. Light-reflecting portion; 203. Light-absorbing portion; 204. Light-transmitting portion; 2041. Via hole; 2042. Opaque coating; 2043. Transparent material; 2044. Opaque or low-light-transmitting material. 3. Spool; 4. Folding rod assembly; 401. First rod body; 402. Second rod body; 403. First rotating connector; 404. Second rotating connector; 405. Rotating shaft; 406. Drive unit; 407. Rotating via hole; 408. Limiting member; 409. Elastic member; 410. Bulge; 411. Groove; 412. Limiting wall; 501. Limiting groove; 502. Lock tongue; 503. Handle; 504. Lock body; 505. Limiting bulge; 601. Support leg; 602. Limiting protrusion; 603. Mounting rod; 604. Locking piece; 701. Auxiliary irradiation surface; 702. Light-transmitting side; 703. Connecting structure; 704. Limiting structure; 705. Supporting structure.

### DETAILED DESCRIPTION OF THE EMBODIMENTS

To enable those skilled in the art to better understand the present disclosure and to more clearly define the scope of protection of the present disclosure, the present disclosure will be described in detail below with reference to certain specific embodiments. It should be noted that the following are only some specific embodiments of the present disclosure, and are only some of the embodiments of the present disclosure. The specific and direct description of the related structures is only for the convenience of understanding the present disclosure, and the specific features do not necessarily or directly limit the scope of the present disclosure.

Referring to the accompanying drawings, the present disclosure adopts the following technical solution: A photographic accessory, including a housing 1 and at least one optical auxiliary component 2 accommodated within the housing 1; at least a part of the optical auxiliary component 2 is provided with at least one of a light-diffusing portion 201, a light-reflecting portion 202, a light-absorbing portion 203, and a light-transmitting portion 204; at least one opening 101 is provided on the housing 1; when at least a part of the optical auxiliary component 2 extends out from the opening 101, at least one of the light-diffusing portion 201, the light-reflecting portion 202, the light-absorbing portion 203, and the light-transmitting portion 204 is in an unfolded state.

Light is directed to a first side of the optical auxiliary component 2 and passes through the light-diffusing portion 201 before exiting from an auxiliary irradiation surface 701 of the light-diffusing portion 201 located on a second side of the optical auxiliary component 2, and the light-diffusing portion 201 includes a light-diffusing cloth or light-diffusing paper.

Light is directed to the first side of the optical auxiliary component 2, light is reflected after passing through the light-reflecting portion 202, and the light-reflecting portion 202 is a reflective coating.

Light is directed to the first side of the optical auxiliary component 2, light passing through the light-absorbing portion 203 is partially absorbed and reflected, and the light-absorbing portion 203 is made of black velvet.

Light is directed to the first side of the optical auxiliary component 2, causing the light to pass through the light-transmitting portion 204 and then transmit from a light-transmitting side 702 of the light-transmitting portion 204 located on the second side of the optical auxiliary component 2, in which the light-transmitting portion 204 is a via hole 2041 opened on the optical auxiliary component 2, or the optical auxiliary component 2 is made of transparent material 2043, and the optical auxiliary component 2 is coated with at least an opaque coating 2042, with light passing through the transparent material 2043 that is not coated with the opaque coating 2042 and being emitted.

The light-diffusing portion 201 includes a light-diffusing cloth or light-diffusing paper, or other materials that can be used for light-diffusing;
the light-reflecting portion 202 is a reflective coating;
the light-absorbing portion 203 is made of black velvet or other light-absorbing material;
the optical auxiliary component 2 is made of an opaque or low-light-transmitting material 2044, and the light-transmitting portion 204 is a via hole 2041 opened on the optical auxiliary component 2, or
the optical auxiliary component 2 is made of transparent material 2043, and the optical auxiliary component 2 is coated with at least an opaque coating 2042, with light passing through the transparent material 2043 that is not coated with the opaque coating 2042 and being emitted. The opaque coating 2042 can be disposed on any side of the optical auxiliary component 2, as shown in FIGS. 5-7.

The difference between the light-transmitting portion 204 and the light-diffusing portion 201 is that the light-transmitting portion 204 does not block light, and the shape of the via hole 2041 or the area not coated with the opaque coating 2042 can be changed. Then when a camera or video camera passes through this part, the image obtained is that the image is formed within the outer contour that matches the shape of the part.

In this embodiment, only one optical auxiliary component 2 is provided, and the optical auxiliary component 2 can perform only one function. For example, a part of the optical auxiliary component 2 is provided with a light-transmitting portion 204; or the optical auxiliary component 2 is an opaque cloth with via holes opened in it, and filters such as red or yellow filters are secured to the via holes; or the entire optical auxiliary component 2 is the light-diffusing portion 201, as shown in FIG. 5. For example, the light-diffusing portion 201 can be made of light-diffusing cloth.

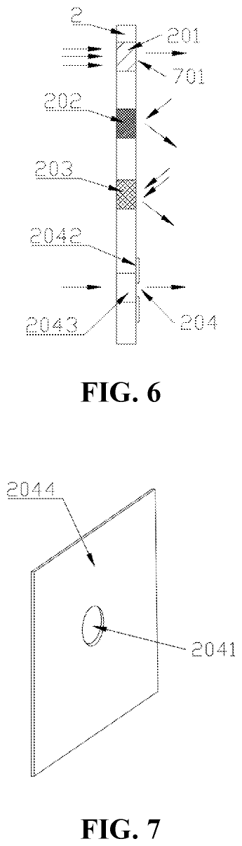

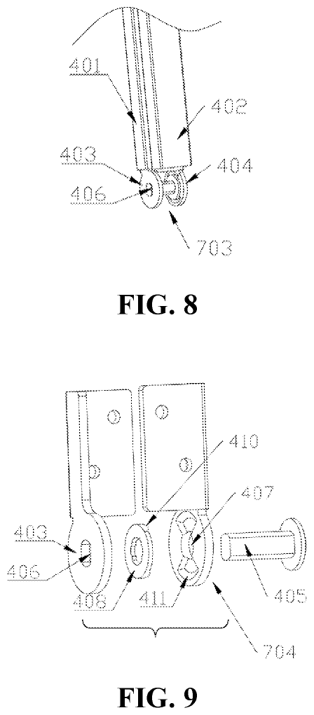

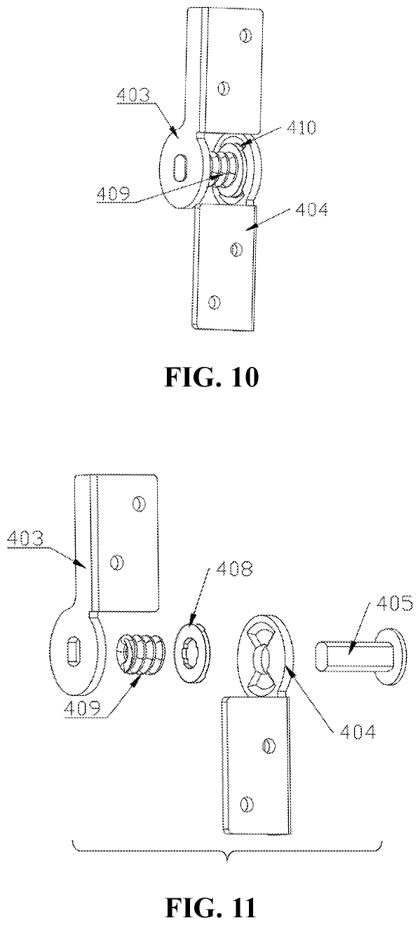

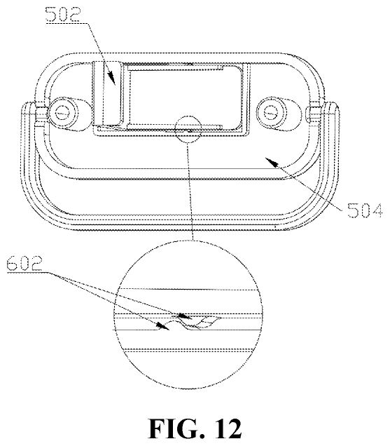

In other embodiments, the preceding light-transmitting portion 204, the light-diffusing portion 201, the light-reflecting portion 202, and the light-absorbing portion 203 can be integrated into a single optical auxiliary component 2, as shown in FIG. 6.

In other embodiments, three optical auxiliary components 2 can be provided, each individually disposed within the housing 1; the first optical auxiliary component 2 can be entirely made of a light-diffusing cloth, the second optical auxiliary component 2 can be entirely made of reflective cloth, namely, at least one side of the cloth is coated with reflective material, and the third optical auxiliary component 2 is made of black cloth to absorb light.

In this embodiment, the optical auxiliary component 2 is made of a flexible material; in other embodiments, the optical auxiliary component 2 includes several rigid components that are movably or flexibly connected so that the optical auxiliary component 2 as a whole is at least partially bendable or foldable.

In this embodiment, the optical auxiliary component 2 is wound on a spool 3 and placed inside the housing 1, and a coil spring can be configured on the spool 3 to facilitate automatic accommodation and reset. In other embodiments, the optical auxiliary component 2 is folded and placed inside the housing 1.

In this embodiment, the supporting structure 705 acts on the optical auxiliary component 2 to at least partially unfold the optical auxiliary component 2.

The supporting structure 705 includes at least one folding rod assembly 4, the folding rod assembly 4 includes a first rod body 401 and a second rod body 402, the first rod body 401 is hinged to the second rod body 402, and the first rod body 401 and the second rod body 402 are rotatably connected by means of a connecting structure 703.

The connecting structure 703 includes a first rotating connector 403 connected to the first rod body 401, a second rotating connector 404 fixedly connected to the second rod body 402, and a rotating shaft 405 connecting the first rotating connector 403 and the second rotating connector 404; the second rotating connector 404 is provided with a drive unit 406 to drive the rotating shaft 405 to rotate, and the first rotating connector 403 is provided with a rotating via hole 407 to allow the rotating shaft 405 to rotate circumferentially within the rotating via hole 407.

The connecting structure 703 further includes a limiting structure 704, and the limiting structure 704 includes a limiting member 408 that rotates with the rotating shaft 405, at least two bulges 410 respectively provided on the opposite contact surfaces of the limiting member 408 and the first rotating connector 403, and a groove 411 fitted with the bulges 410.

When the second rotating connector 404 drives the limiting member 408 to rotate, the bulges 410 leave the groove 411 and enter a next groove 411 to achieve a stable connection.

The two bulges 410 are arranged at 180 degrees to limit and lock the first rod body 401 and the second rod body 402 in a folded state and in an unfolded straight state; the limiting structure 704 further includes an elastic member 409 disposed between the second rotating connector 404 and the limiting member 408 to abut the limiting member 408 against the first rotating connector 403. The aforementioned elastic member 409 can be a spring structure, or a material with elasticity, such as silicone, or other materials that can allow the limiting member 408 to abut against the inner wall of the second rotating connector 404. In this embodiment, a corrugated rubber/silicone material is used.

The connecting structure 703 described above enables the folding and unfolding of the first rod body 401 and the second rod body 402, thereby increasing stability.

In this embodiment, a first end of the optical auxiliary component 2 is secured on the spool 3, a second end is provided with a support rod 102, a first end of the first rod body 401 is hinged to the support rod 102, a second end of the second rod body 402 is hinged to an inner wall of the housing 1, and a second end of the first rod body 401 is hinged to a first end of the second rod body 402. The support rod 102 forms a cover of the housing 1.

A length of the support rod 102 is adapted to a width of the optical auxiliary component 2, and two folding rod assemblies 4 are provided and respectively arranged at both ends of the support rod 102, so that when the folding rod assemblies 4 are unfolded, they are placed on both sides of the optical auxiliary component 2 to prevent blocking light.

In other embodiments, the supporting structure 705 can also be a bracket with a hook mounted on the bracket. When in use, the housing 1 is fixedly placed on the bracket, and then the support rod 102 is stretched and hung on the hook to realize the stretching and unfolding of the optical auxiliary component 2.

A limiting wall 412 is provided on the support rod 102 at the hinge point with the first rod body 401.

A limiting groove 501 is provided on the inner wall of the housing 1, and a lock tongue 502 is movably connected to the cover, the lock tongue 502 disengaging from or entering the limiting groove 501 to achieve unlocking or locking. A handle 503 is provided on the cover. The top of the cover is fixedly mounted with a lock body 504, and the lock tongue 502 is at least partially disposed inside the lock body 504. Limiting bulges 505 are provided on an outer wall of the lock tongue 502 and an inner wall of the lock body 504 to limit the lock tongue 502 in the unlocked and locked states.

The housing 1 is rotatably connected to a support leg 601, and the housing 1 is provided with a limiting protrusion 602 for limiting rotation angles of the support leg 601. The housing 1 is detachably connected to a mounting rod 603, and the mounting rod 603 is limited and secured by means of a locking piece 604 of an existing structure and can be secured to other brackets.

The mounting method is not limited to the above structure; it can also be a clamp structure that holds it to an existing bracket.

Compared with the prior art, the advantages of the present disclosure are as follows: The present disclosure features a simple structure and can be used as a fill board, reflector or diffuser during photography and videography.

The technical solution of the present disclosure has been described in conjunction with the preferred embodiments shown in the accompanying drawings. However, it will be readily understood by those skilled in the art that the scope of protection of the present disclosure is obviously not limited to these specific embodiments. Without departing from the principles of the present disclosure, those skilled in the art can make equivalent changes or substitutions to the relevant technical features, and the technical solutions after these changes or substitutions will all fall within the protection scope of the present disclosure.

What is claimed is:

1. A photographic accessory, comprising a housing and at least one optical auxiliary component accommodated within the housing, wherein
at least a part of the optical auxiliary component is provided with at least one of a light-diffusing portion, a light-reflecting portion, a light-absorbing portion, and a light-transmitting portion; and
at least one opening is provided on the housing; when at least a part of the optical auxiliary component extends out from the opening, at least one of the light-diffusing portion, the light-reflecting portion, the light-absorbing portion, and the light-transmitting portion is in an unfolded state.

2. The photographic accessory according to claim 1, wherein light is directed to a first side of the optical auxiliary component and passes through the light-diffusing portion before exiting from an auxiliary irradiation surface of the light-diffusing portion located on a second side of the optical auxiliary component, and the light-diffusing portion comprises a light-diffusing cloth or light-diffusing paper.

3. The photographic accessory according to claim 1, wherein light is directed to the first side of the optical auxiliary component, light is reflected after passing through the light-reflecting portion, and the light-reflecting portion is a reflective coating.

4. The photographic accessory according to claim 1, wherein light is directed to the first side of the optical auxiliary component, light passing through the light-absorbing portion is partially absorbed and reflected, and the light-absorbing portion is made of black velvet.

5. The photographic accessory according to claim 1, wherein light is directed to the first side of the optical auxiliary component, causing the light to pass through the light-transmitting portion and then transmit from a light-transmitting side of the light-transmitting portion located on the second side of the optical auxiliary component; wherein
the light-transmitting portion is a via hole opened on the optical auxiliary component, or
the optical auxiliary component is made of transparent material, and the optical auxiliary component is coated with at least an opaque coating, with light passing through the transparent material that is not coated with an opaque coating and being emitted.

6. The photographic accessory according to claim 1, wherein the optical auxiliary component is made of an opaque or low-light-transmitting material.

7. The photographic accessory according to claim 1, wherein the optical auxiliary component is made of a flexible material so that the optical auxiliary component is wound onto a spool inside the housing after being accommodated.

8. The photographic accessory according to claim 1, wherein the optical auxiliary component comprises a plurality of rigid components that are movably or flexibly connected so that the optical auxiliary component can be at least partially bent or folded, and so that the optical auxiliary component is placed in the housing after being folded or bent.

9. The photographic accessory according to claim 1, further comprising a supporting structure, wherein the supporting structure acts on the optical auxiliary component to at least partially unfold the optical auxiliary component.

10. The photographic accessory according to claim 9, wherein the supporting structure comprises at least one folding rod assembly, the folding rod assembly comprises a first rod body and a second rod body, and the first rod body and the second rod body are rotatably connected by means of a connecting structure.

11. The photographic accessory according to claim 10, wherein the connecting structure comprises a first rotating connector connected to the first rod body, a second rotating connector connected to the second rod body, and a rotating shaft connecting the first rotating connector and the second rotating connector; the second rotating connector is provided with a drive unit to drive the rotating shaft to rotate, and the first rotating connector is provided with a rotating via hole to allow the rotating shaft to rotate circumferentially within the rotating via hole.

12. The photographic accessory according to claim 11, wherein the connecting structure further comprises a limiting structure, and the limiting structure comprises a limiting member that rotates with the rotating shaft, at least two bulges respectively provided on the opposite contact surfaces of the limiting member and the first rotating connector, and a groove fitted with the bulges.

13. The photographic accessory according to claim 12, wherein the two bulges are arranged at 180 degrees to limit and lock the first rod body and the second rod body in a folded state and in an unfolded straight state; and/or, the limiting structure further comprises an elastic member disposed between the second rotating connector and the limiting member to abut the limiting member against the first rotating connector.

14. The photographic accessory according to claim 9, wherein a first end of the optical auxiliary component is secured on the spool within the housing, a second end is provided with a support rod, a first end of the first rod body is hinged to the support rod, a second end of the second rod body is hinged to an inner wall of the housing, and a second end of the first rod body is hinged to a first end of the second rod body.

15. The photographic accessory according to claim 14, wherein a length of the support rod is adapted to a width of the optical auxiliary component, and two folding rod assemblies are provided and respectively arranged at both ends of the support rod, so that when the folding rod assemblies are unfolded, they are placed on both sides of the optical auxiliary component to prevent blocking light.

16. The photographic accessory according to claim 14, wherein a limiting wall is provided on the support rod at the hinge point with the first rod body.

17. The photographic accessory according to claim 15, wherein a limiting groove is provided on the inner wall of the housing, and a lock tongue is movably connected to the cover, the lock tongue disengaging from or entering the limiting groove to achieve unlocking or locking.

18. The photographic accessory according to claim 14, wherein the support rod serves as the cover of the housing, and a handle is mounted on the support rod serving as the cover.

19. The photographic accessory according to claim 1, wherein a support leg is rotatably connected to the housing, and a limiting protrusion for limiting rotation angles of the support leg is provided on the housing.

20. The photographic accessory according to claim 1, wherein a mounting rod is detachably connected to the housing, and the mounting rod is limited and secured by means of a locking piece.
